(19) United States
(12) Patent Application Publication
(10) Pub. No.: US 2011/0138802 A1
(43) Pub. Date: Jun. 16, 2011

(54) ELECTRIC BOOSTER

(76) Inventor: Masaru SAKUMA, Kanagawa (JP)

(21) Appl. No.: 12/914,211

(22) Filed: Oct. 28, 2010

(30) Foreign Application Priority Data
Nov. 2, 2009 (JP) 251939/2009

(51) Int. Cl. B60T 13/74

(52) U.S. Cl. 60/545

(57) ABSTRACT

Provided is an electric booster capable of suppressing a fluctuation in pushing force on a brake pedal. The electric booster includes a first offset spring and a second offset spring, which have a non-linear characteristic increasing with an increase in advancing amount (amount of forward movement of a booster piston with respect to an input piston) as the booster piston of a master cylinder is moved in a pressure-intensifying direction. An electric actuator is controlled (advancement control is performed) so as to increase the advancing amount as the booster piston of the master cylinder is moved in the pressure-intensifying direction to perform a pressure reduction operation associated with regenerative cooperative control at the time of advancement control. Therefore, even when a pressure reduction associated with the regenerative cooperative control is performed at the time of a low hydraulic pressure or a high hydraulic pressure, a reaction force to the pedal can have the same value or approximately the same value before and after the pressure reduction. Specifically, the pressure reduction operation associated with the regenerative cooperative control can be realized without causing a great fluctuation in pushing force on the brake pedal at the time of the low hydraulic pressure or the high hydraulic pressure, and in turn, over a wide range of hydraulic pressure region.

### BACKGROUND OF THE INVENTION

The present invention relates to an electric booster used for a brake mechanism for a vehicle such as an automobile.

Conventionally, as an example of the electric booster, there is known an electric booster which includes an input member which moves forward and backward by an operation of a brake pedal, an assist member, provided so as to be movable relative to the input member, for moving a piston of a master cylinder, an electric actuator for moving forward and backward the assist member, and a spring member, provided between the input member and the assist member, for retaining the input member and the assist member in neutral positions of the relative movement when the brake pedal is not operated (see Japanese Patent Application Publication No. 2007-191133).

### SUMMARY OF THE INVENTION

By the way, in the electric booster as described above, a reduction in reaction force to the pedal, which occurs when a brake hydraulic pressure is reduced at the time of regenerative cooperative braking, is compensated for by a force which is generated by the spring member along with the movement of the input member and the piston of the master cylinder relative to each other. Specifically, when the piston moves in a direction in which the pressure is reduced, a spring force applied by the spring member to the input member (and, in turn, to the pedal) is reduced as a result of the movement. On the other hand, a force (force in a direction opposite to that of the spring force) applied by the brake hydraulic pressure to the input member (and, in turn, to the pedal) is reduced by the pressure reduction to cancel out the reduction in the spring force. The compensation (cancellation) performance is dependent on a fluid volume-hydraulic pressure characteristic representing a relation between a fluid volume (which is proportional to the amount of movement of the piston) and a hydraulic pressure of a brake system. Therefore, when the fluid volume-hydraulic pressure characteristic is non-linear, it is difficult to fully demonstrate the compensation performance over a wide range of hydraulic pressure region. Therefore, a fluctuation sometimes occurs in a pushing force on the brake pedal when the regenerative cooperative braking is performed.

The present invention has an object to provide an electric booster capable of suppressing a fluctuation In pushing force on a brake pedal.

An electric booster according to the present invention includes: an input member which moves forward and backward by an operation of a brake pedal; an assist member, provided so as to be movable relative to the input member, for moving a piston of a master cylinder; an electric actuator for moving forward and backward the assist member; control means for controlling the electric actuator according to movement of the input member by the brake pedal; and a spring member, provided between the input member side and the assist member side, for generating a biasing force applied to the input member, the biasing force varying according to an amount of relative movement between the input member and the assist member, in which: a spring constant of the spring member is set so as to vary according to an advancing amount of the assist member with respect to the input member; and the control means performs control so as to increase the advancing amount as the input member moves in a pressure-intensifying direction and is configured so that a change in the spring constant with respect to a stroke of the piston corresponds to a change in gradient of a brake hydraulic pressure with respect to the stroke of the piston.

### BRIEF DESCRIPTION OF THE DRAWINGS

FIG. 1 is a sectional view illustrating different planes at 90 degrees to each other with an alternate long and short dash line in overall structure of an electric booster illustrated as an embodiment of the present invention.

FIG. 2 is a view illustrating an initial state of the electric booster of a first reference example.

FIG. 3A is a view illustrating a state at the time of regenerative cooperation control performed at a low hydraulic pressure in the first reference example, the state being before pressure reduction associated with the regenerative cooperative control.

FIG. 3B is a view illustrating a state at the time of the regenerative cooperation control performed at the low hydraulic pressure in the first reference example, the state being after the pressure reduction associated with the regenerative cooperative control.

FIG. 4 is a graph showing a correspondence relation between a brake hydraulic pressure and a piston position (piston stroke) at the time of a regenerative cooperative control operation of general electric boosters including those of the first reference example and this embodiment.

FIG. 5A is a view illustrating a state at the time of the regenerative cooperative control performed at a high hydraulic pressure in the first reference example, the state being before the pressure reduction associated with the regenerative cooperative control.

FIG. 5B is a view illustrating a state at the time of the regenerative cooperative control performed at the high hydraulic pressure in the first reference example, the state being after the pressure reduction associated with the regenerative cooperative control.

FIG. 6 is a view illustrating advancement control (advancement control under constant spring-constant characteristic conditions) executed by a controller of a second reference example, and illustrating an initial state of execution of the advancement control.

FIG. 7 is a view illustrating an operation performed in a low hydraulic pressure state in the advancement control of the second reference example.

FIG. 8 is a view illustrating an operation performed in a high hydraulic pressure state in the advancement control of the second reference example.

FIG. 9 is a graph illustrating a correspondence relation between an advancing amount of the piston relative to the brake hydraulic pressure at the time of the advancement control and a spring constant of the offset springs in the second reference example.

FIG. 10 is a graph illustrating a correspondence relation between the advancing amount of the piston relative to the brake hydraulic pressure at the time of the advancement control and the spring constant of the offset springs in this embodiment.

FIG. 11A is a view illustrating a state at the time of the pressure reduction associated with the regenerative cooperative control performed at the low hydraulic pressure in this embodiment, the state being before the pressure reduction associated with the regenerative cooperative control.

FIG. 11B is a view illustrating a state at the time of the pressure reduction associated with the regenerative cooperative control performed at the low hydraulic pressure in this embodiment, the state being after the pressure reduction associated with the regenerative cooperative control.

FIG. 12A is a view illustrating a state at the time of the regenerative cooperative control performed at the high hydraulic pressure in this embodiment, the state being before the pressure reduction associated with the regenerative cooperative control.

FIG. 12B is a view illustrating a state at the time of the regenerative cooperative control performed at the high hydraulic pressure in this embodiment, the state being after the pressure reduction associated with the regenerative cooperative control.

### DETAILED DESCRIPTION OF THE INVENTION

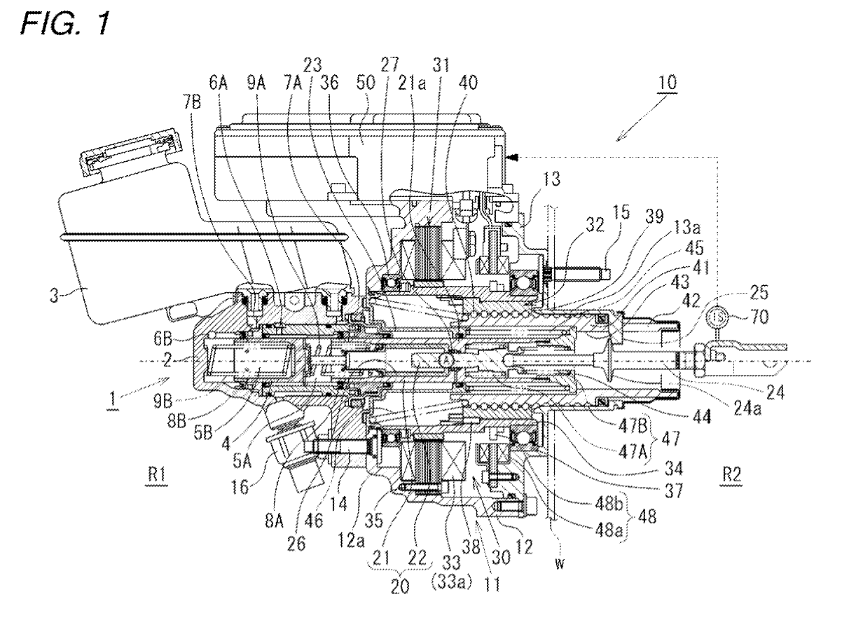

Hereinafter, an electric booster according to an embodiment of the present invention is described based on FIGS. 1, 4, 10, 11A, 11B, 12A, and 12B.

An electric booster 10 according to this embodiment includes, as illustrated in FIG. 1, a casing 11 which has one end fixed to a partition wall W separating an engine room R1 and a cabin R2 from each other and the other end to which a tandem master cylinder (hereinafter, also referred to simply as “master cylinder”) 1 is connected. Note that, hereinafter, the engine room R1 side is referred to as a front side and the cabin R2 side is referred to as a rear side for the convenience of the description. The casing 11 includes a casing main body 12 having a cylindrical shape and a rear cover 13 bolted to a rear end of the caring main body 12. A stepped front wall 12a is provided to a front end of the casing main body 12 so as to be formed integrally therewith. The master cylinder 1 is fixedly connected to the front wall 12a with a stud bolt 14. The rear cover 13 is fixedly connected to the partition wall W with a stud bolt 15. In the fixedly connected state, a cylindrical guide portion 13a integrally formed with the rear cover 13 is extended into the cabin R2 through the partition wall W.

A piston assembly 20 described below, which is also used as a primary piston of the master cylinder 1, and an electric actuator 30 described below for driving a booster piston 21 constituting the piston assembly 20 are housed within the casing 11. Moreover, on the top of the casing 11 (casing main body 12), an ECU 50 corresponding to control means is provided.

The master cylinder 1 includes a cylinder main body 2 with a closed end and a reservoir 3. On a bottom side (bottom end side) of the cylinder main body 2, a secondary piston 4 which forms a pair with the piston assembly 20 serving as the primary piston is slidably provided. Inside the cylinder main body 2, a primary chamber 5A and a secondary chamber 5B are defined by the piston assembly 20 (hereinafter, also referred to as “piston 20” for the convenience of the description) and the secondary piston 4 as two hydraulic pressure chambers. By the primary chamber 5A and the secondary chamber 5B, a brake fluid enclosed in the primary chamber 5A and the secondary chamber 5B is pressure-fed to wheel cylinders (not shown), which are provided to respective wheels, through eject ports 6A and 6B provided to the cylinder main body 2, according to the forward movement of the two pistons 20 and 4.

Relief ports 7A and 7B which respectively bring the primary chamber 5A and the secondary chamber 5B into communication to the reservoir 3 are provided to the cylinder main body 2. On an inner surface of the cylinder main body 2, a pair of seal members 8A and 8B are provided ahead of the relief ports 7A and 7B so as to correspond to the relief ports 7A and 7B. In the primary chambers 5A and the secondary chamber 5B, return springs 9A and 9B for constantly biasing the piston assembly 20 serving as the primary piston and the secondary piston 4 in a backward direction are respectively provided. The primary chamber 5A and the secondary chamber 5B are held in communication with to the reservoir 3 respectively through the relief ports 7A and 7B when the two pistons 20 and 4 are respectively at the ends of the backward movement. In this manner, a necessary amount of brake fluid is supplied from the reservoir 3 to each of the primary chamber 5A and the secondary chamber 5B.

Moreover, a pressure sensor 16 for detecting pressures of the primary chamber 5A and the secondary chamber 5B is provided to the cylinder main body 2.

The piston assembly 20 includes a booster piston 21 and an input piston 22. The solid input piston 22 is provided inside the booster piston 21 having a cylindrical shape so as to be movable relative thereto.

The booster piston 21 is slidably inserted into a cylindrical guide 23 fitted to the front wall 12a of a front end of the casing main body 12, and has a front end portion extended into the primary chamber 5A of the master cylinder 1. On the other hand, the input piston 22 is slidably inserted through an annular wall portion 21a formed on an inner circumference of the booster piston 21, and has a front end portion extended into the primary chamber 5A of the master cylinder 1 as in the case of the booster piston. Between the booster piston 21 and the cylinder main body 2 of the master cylinder 1, the seal member 8A is provided. Between the booster piston 21 and the input piston 22, a seal member 27 is provided on the inner side of the annular wall portion 21a of the booster piston 21. The seal member 27 is retained onto the annular wall portion 21a by a sleeve 26 fitted into an inner circumference of a front portion of the booster piston 21. The seal members 8A and 27 prevent the brake fluid from leaking from the primary chamber 5A to the outside of the master cylinder 1.

On the other hand, a distal end portion of an input rod 24 which operates in conjunction with a brake pedal is turnably connected to a rear end portion of the above-mentioned input piston 22. The input piston 22 is moved forward and backward inside the booster piston 21 by an operation of the brake pedal (not shown) (pedal operation). In the middle of the input rod 24, a flange portion 24a formed by increasing a diameter is integrally formed therewith. The flange portion 24a of the input rod 24 abuts against an inward projection 25 integrally formed with a rear end of the cylindrical guide portion 13a of the rear cover 13 to restrict the movement toward the rear side (cabin R2 side). Specifically, the position at which the flange portion 24a of the input rod 24 is brought into abutment against the inward projection 25 of the rear cover 13 corresponds to a position at which the input piston 22 is situated at the rearmost end of the backward movement thereof. In this embodiment, the input piston 22 and the input rod 24 constitute an input member.

The above-mentioned electric actuator 30 includes an electric motor 31 and a ball screw mechanism (rotary-to-linear motion converting mechanism) 32 for converting the rotation of the electric motor 31 into linear movement and transmitting the linear movement to the booster piston 21. In this embodiment, the booster piston 21 constitutes an assist member.

The electric motor 31 includes a stator 33 having a plurality of coils 33a and a hollow rotor 34 which is rotated by energization of the stator 33. The stator 33 is fixed to the casing main body 12 with a bolt 35. The rotor 34 is turnably supported by the casing main body 12 and the rear cover 13 through an intermediation of bearings 36 and 37.

The ball screw mechanism 32 includes a nut member 39 fitted into and fixed to the rotor 34 of the electric motor 31 with a key 38 so as not to be rotatable and a hollow threaded shaft (linearly moving member) 41 meshed with the nut member 39 through an intermediation of balls 40. A slit 42, which extends axially, is provided to a rear end portion of the threaded shaft 41. The inward projection 25 of the rear cover 13 is inserted into the slit 42. Specifically, the threaded shaft 41 is provided inside the casing 11 so as not to be turnable. Therefore, when the nut member 39 rotates integrally with the rotor 34, the threaded shaft 41 moves linearly.

On the other hand, an annular level-difference portion 43 is formed on an inner surface of the threaded shaft 41. Against the annular level-difference portion 43, a flange member 44 screwed in a rear end portion of the booster piston 21 abuts. Moreover, between the flange member 44 and the cylindrical guide 23 fitted into the casing main body 12, a return spring 45 is interposed. The booster piston 21 maintains a state where the flange member 44 is constantly brought into abutment against the annular level-difference portion 43 of the threaded shaft 41 by the return spring 45. Therefore, when the threaded shaft 41 is moved forward according to the rotation of the nut member 39, the booster piston 21 is pushed by the threaded shaft 41 to move forward. A pressor bar spring 46 for biasing the threaded shaft 41 backward so as to restrict the unexpected forward movement of the threaded shaft 41 is interposed between the threaded shaft 41 and the cylindrical guide 23. In this embodiment, the threaded shaft 41 is positioned at the end of the backward movement at which a start point of the slit 42 is brought into abutment against the inward projection 25 of the rear cover 13 when the brake pedal is not operated by the biasing forces of the return spring 45 and the pressor bar spring 46. In response, the booster piston 21 is positioned at the end of the backward movement at which the booster piston is brought into abutment against the annular level-difference portion 43 of the threaded shaft 41 situated at the end of the backward movement when the brake pedal is not operated.

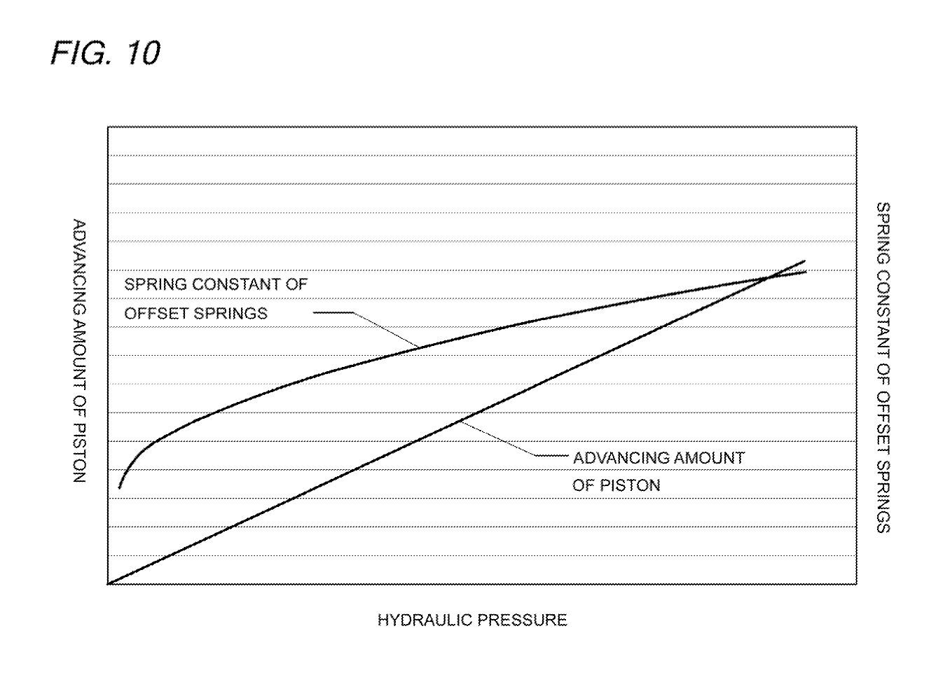

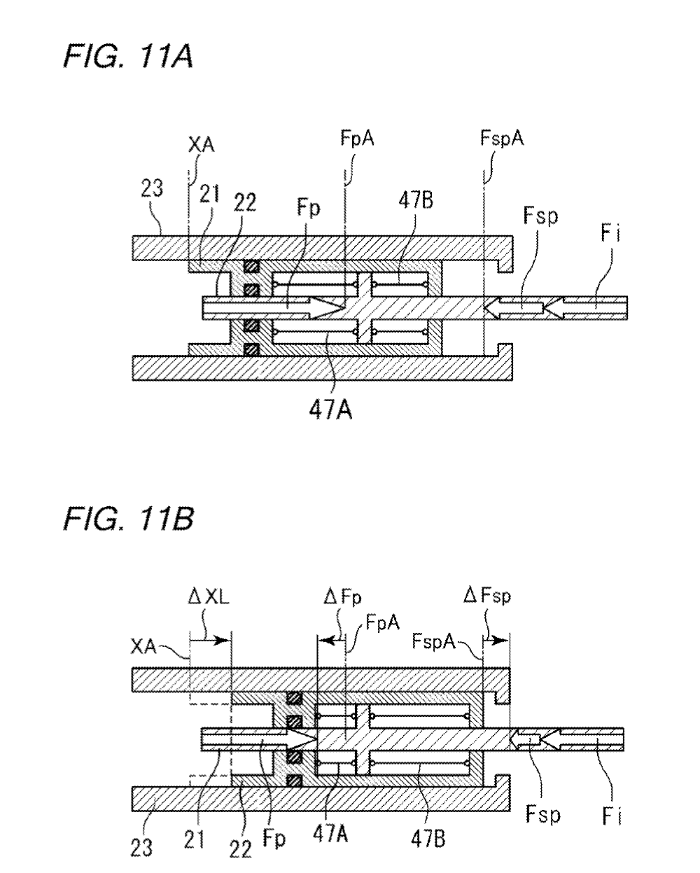

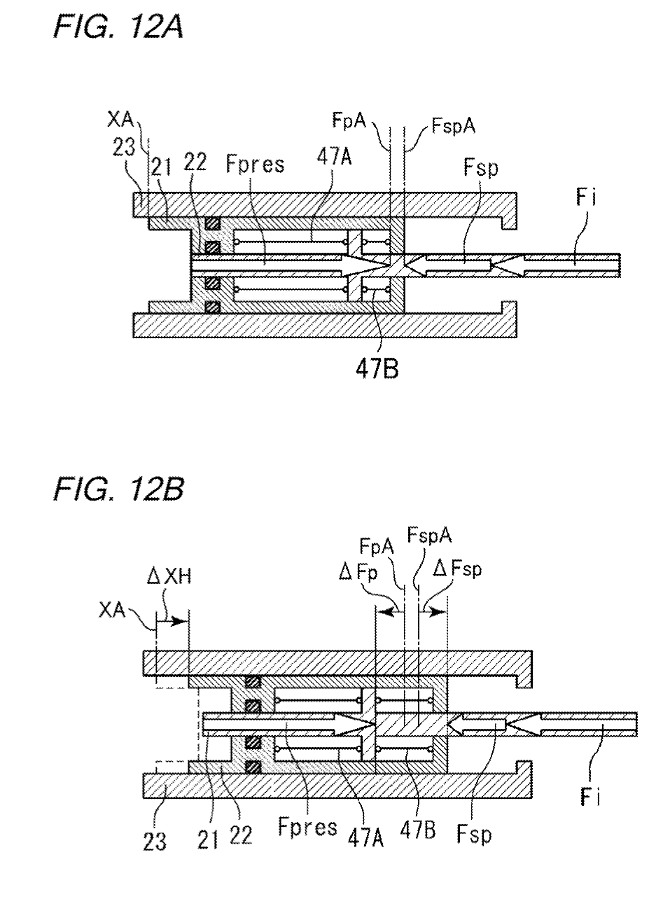

Moreover, between the booster piston 21 and the input piston 22 constituting the piston assembly 20, a pair of offset springs (spring means) 47 are provided, as also illustrated in FIGS. 11A, 11B, 12A, and 12B. The pair of offset springs 47 play a role of retaining the booster piston 21 and the input piston 22 in neutral positions of the relative movement when the brake pedal is not operated. In the following description, the one of the pair of offset springs 47, which is illustrated on the left in FIG. 11, is referred to as a first offset spring 47A, whereas the one illustrated on the right in FIG. 11, is referred to as a second offset spring 47B. As the first offset spring 47A and the second offset spring 47B, coil springs are used. An individual spring constant of each of the first offset spring 47A and the second offset spring 47B or a combined, spring constant obtained by combining the spring constants of the two spring constants has a non-linear characteristic, as illustrated in FIG. 10, which increases with an increase in advancing amount of the booster piston 21 (assist member) relative to a brake hydraulic pressure, and in turn, to the input piston 22 (input member). Here, the “advancing amount” means a distance of the forward movement of the booster piston 21 relative to the input piston 22 when the neutral position when the brake pedal is not operated is used as a reference. For example, the amount of forward movement when the input piston 22 is moved forward by one unit and the booster piston 21 is moved forward by two units based on the position when the brake pedal is not operated is one unit.

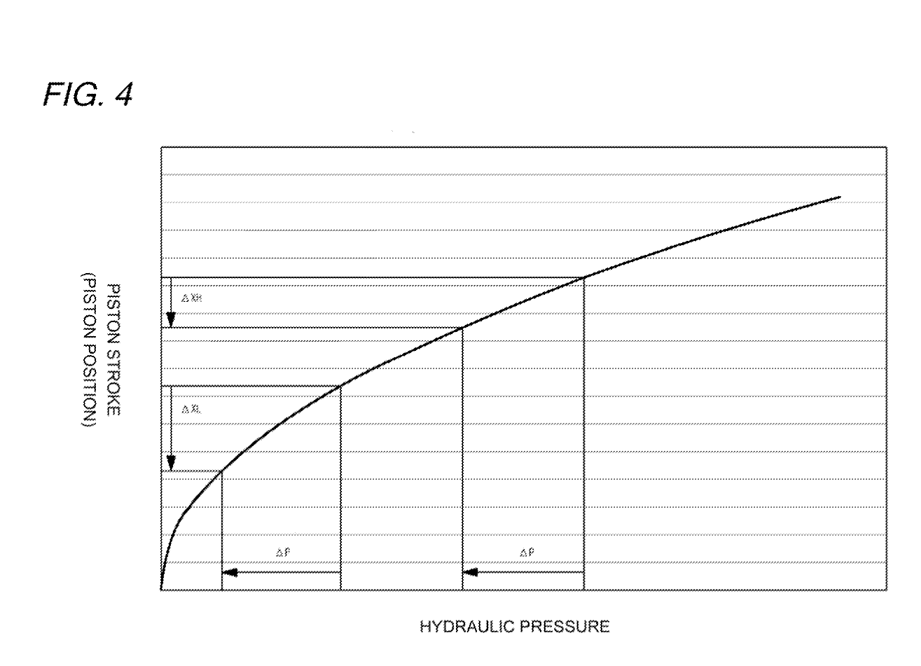

A characteristic of each of the spring constants of the first offset spring 47A and the second offset spring 47B or the combined spring constant obtained by combining the spring constants of the two spring constants is set, for example, as a non-linear characteristic illustrated in FIG. 10, so as to be close to a correspondence relation between the brake hydraulic pressure and a piston stroke (piston position) illustrated in FIG. 4, and in turn, to a brake hydraulic pressure-fluid volume characteristic which is equivalent to the correspondence relation, in a brake system for a vehicle to which the electric booster 10 of this embodiment is mounted, specifically, the entire oil hydraulic circuit including a pipe connected to the master cylinder 1, the wheel cylinders, and the like.

The non-linear characteristic as described above can be provided to the spring constants of the first offset spring 47A and the second offset spring 47B by, for example, constituting at least one of the springs 47A and 47B (for example, the spring 47A) as a so-called irregular pitch coil spring having a varying axial pitch between coils.

Referring to FIG. 1, a resolver (rotation sensor) 48 for detecting an absolute displacement of the booster piston 21 relative to a vehicle body, that is, a rotational displacement of the electric motor 31, and, consequently, the position after the movement of the assist member, based on the rotational displacement of the electric motor 31 is provided inside the casing 11. The resolver 48 includes a resolver stator 48a bolted to the casing 11 (casing main body 12) and a resolver rotor 48b provided on an outer circumferential surface of the rotor 34 of the electric motor 31.

Moreover, in this embodiment, a stroke sensor 70 for detecting the amount of stroke of the input rod 24, and in turn, that of the input piston 21 is provided.

Detection signals of the stroke sensor 70 and the resolver 48 are transmitted to the ECU 50 corresponding to the control means. The ECU 50 controls the electric motor 31 of the electric actuator 30 according to the movement of the input piston 22 by the operation of the brake pedal. In the control, the ECU 50 controls the rotation of the electric motor 31 so as to increase the advancing amount in proportion to the amount of movement of the input piston 22 according to the movement of the input piston 22 corresponding to the input member in a pressure-intensifying direction. Hereinafter, the above-mentioned control is referred to as advancement control.

In this embodiment, a specific configuration, in which the spring constant of each of the first offset spring 47A and the second offset spring 47B or the combined spring constant obtained by combining the spring constants of the two springs has a non-linear characteristic which increases with an increase in the advancing amount of the booster piston 21 relative to the input piston 22 as described above and in addition, the ECU 50 executes the advancement control, is used. Therefore, a change in each of the above-mentioned spring constants with respect to the stroke of the booster piston 21 or a change in the above-mentioned combined spring constant is configured so as to correspond to a change in gradient of the brake hydraulic pressure with respect to the stroke of the booster piston 21. Therefore, as described below, at the time of pressure reduction performed in association with the regenerative cooperative control, which is so-called pressure reduction associated with the regenerative cooperative control, the generation of a fluctuation in pushing force on the brake pedal is suppressed over a wide range of hydraulic pressure region.

As described above, the advancement control executed by the ECU 50 under conditions where the first offset spring 47A and the second offset spring 47B are used, which exhibit the non-linear characteristic in which each of the spring constants or the combined spring constant increases with an increase in the advancing amount is hereinafter appropriately referred to as “advancement control under non-linear spring constant characteristic conditions” (also referred to as “advancement control+non-linear characteristic of the offset springs”).

Here, prior to the description of the effects of this embodiment, the case where the regenerative cooperative control is performed in an electric booster which does not perform the above-mentioned advancement control but performs control hereinafter referred to as “equal-magnification control” for moving the booster piston forward by the amount equal to that of the stroke of the input piston is described as a first reference example. Moreover, the case where the regenerative cooperative control is performed in an electric booster which performs control hereinafter referred to as “advancement control under constant spring-constant characteristic conditions”, which corresponds to the advancement control performed under conditions where a pair of offset springs having constant-value spring constants (combined spring constant) are used regardless of the advancing amount is described as a second reference example.

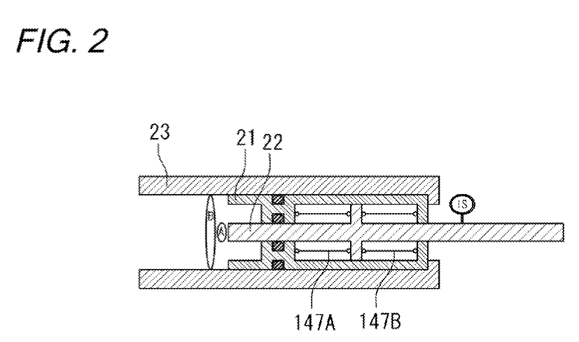

In the first reference example, a first offset spring 147A and a second offset spring 147B which respectively have constant-value spring constants or have a constant-value combined spring constant are provided in place of the first offset spring 47A and the second offset spring 47B of this embodiment, as illustrated in FIGS. 2, 3A, 3B, 5A, and 5B. In the first reference example, an ECU (not shown) for performing the equal-magnification control is provided in the first reference example in place of the ECU 50 of this embodiment.

### EQUAL-MAGNIFICATION CONTROL (FIRST REFERENCE EXAMPLE)

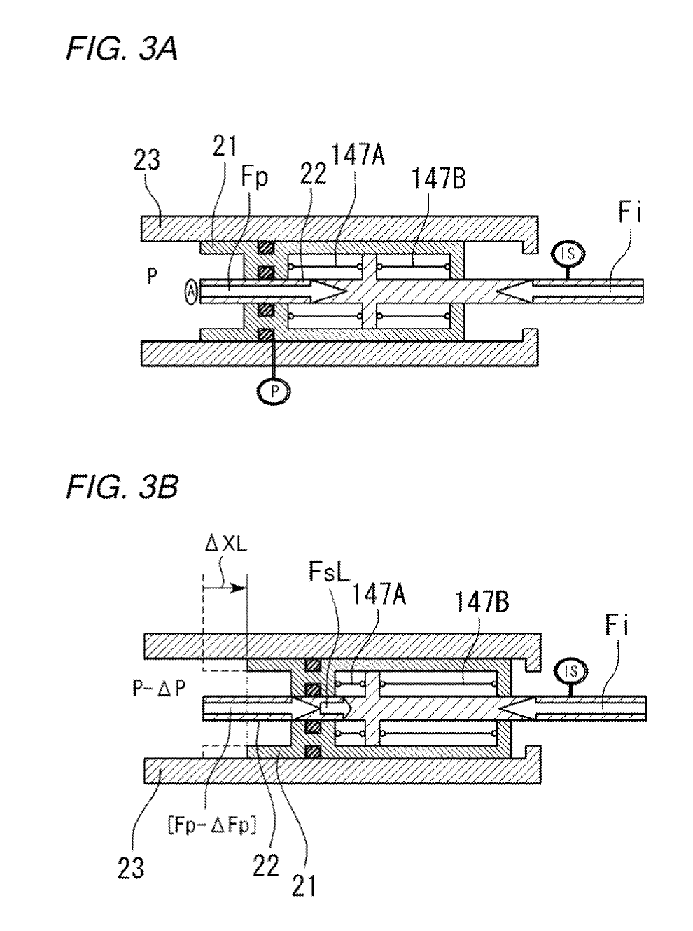

FIGS. 2, 3A, and 3B schematically illustrate an operation of the “equal-magnification control” for moving the booster piston 21 forward by the amount equal to that of the stroke of the input piston 22, which is executed by the ECU of the first reference example. FIG. 2 illustrates an initial state before the equivalent control is executed in the first reference example.

The ECU of the first reference example detects the amount of the stroke of the input rod 24, which is generated along with the operation of the brake pedal, by the stroke sensor 70, and rotates the electric motor 31 in a forward direction so as to move the booster piston 21 forward by the ball screw mechanism 32 by the amount equal to that of the stroke of the input piston 22, as illustrated in FIGS. 2 and 3A, to generate the hydraulic pressure in the primary chamber 5A.

When the hydraulic pressure is generated in the primary chamber 5A with the operation of the brake pedal as described above, a reaction force obtained by multiplying the hydraulic pressure by an area A of an end surface of the input piston 22, which is oriented toward the primary chamber 5A, by the hydraulic pressure acts on the input piston 22 as illustrated in FIG. 3A. On the other hand, the spring force of the first offset spring 147A and the second offset spring 147B, in other word, an offset spring force does not acts on the input piston 22 as far as the equal-magnification control is performed. As a result, a reaction force Fp according to the hydraulic pressure acts on the brake pedal which is pushed by a driver to realize a so-called firm pedal feel. A force Fi corresponding to the firm pedal feel is also referred to as a reaction force on the input member.

Next, an operation at the time of regenerative cooperation control, which is executed in the first reference example, is described referring to FIGS. 1 and 3B.

When regenerative cooperation control is not performed, a braking force obtained according to the amount of operation of the brake pedal corresponds to a frictional braking force alone. On the other hand, at the time of the regenerative cooperative control, it is necessary to reduce the frictional braking force by the amount of a regenerative braking force. Thus, the electric motor 31 is controlled to rotate in a reverse direction to move the booster piston 21 backward by a predetermined amount ΔX to reduce the hydraulic pressure of the primary chamber 5A. Here, the hydraulic pressure of the primary chamber 5A is reduced by the amount of change ΔP, and therefore the reaction force according to the hydraulic pressure is also reduced by a predetermined reaction force ΔFp to be equal to (Fp−ΔFp). On the other hand, the position of the input piston 22 remains unchanged and therefore, the relative movement of the amount of change ΔX which is equal to the predetermined amount ΔX occurs between the booster piston 21 and the input piston 22. Thus, the spring force is increased by the amount obtained by multiplying the amount of change ΔX by the respective spring constants of the first offset spring 147A and the second offset spring 147B, or by a combined spring constant Ksp (Fs=Ksp×ΔX). In this manner, the reduction in reaction force due to the hydraulic pressure can be compensated for by the spring force. As a result, a change in pedal feel of the driver, which is a so-called fluctuation in pushing force, can be reduced. Force balance at this time can be expressed by Formulae (1) and (2).

<Balance Before the Pressure Reduction Associated with the Regenerative Cooperative Control>

Fi (before pressure reduction associated with regenerative cooperative control)=area A×P (1)

<Balance After the Pressure Reduction Associated with the Regenerative Cooperative Control>

Fi (after pressure reduction associated with regenerative cooperative control)=area A×(P−ΔP)+Ksp×ΔX (2)

Here, in order to make Fi (before pressure reduction associated with regenerative cooperative control) and Fi (after pressure reduction associated with regenerative cooperative control) equal to each other, specifically, to suppress the change in pedal feel due to the pressure reduction associated with regenerative cooperative control, a relation expressed by Formula (3) is required.

area A×ΔP=Ksp×ΔX (3)

Based on the above-mentioned formulae, it is understood that, when a ratio (ΔP/ΔX) of the amount of change ΔP in the hydraulic pressure and the amount of change ΔX in the piston stroke is constant independently of a position X of the piston, the change in pedal feel at the time of the regenerative cooperative control can be infinitely reduced.

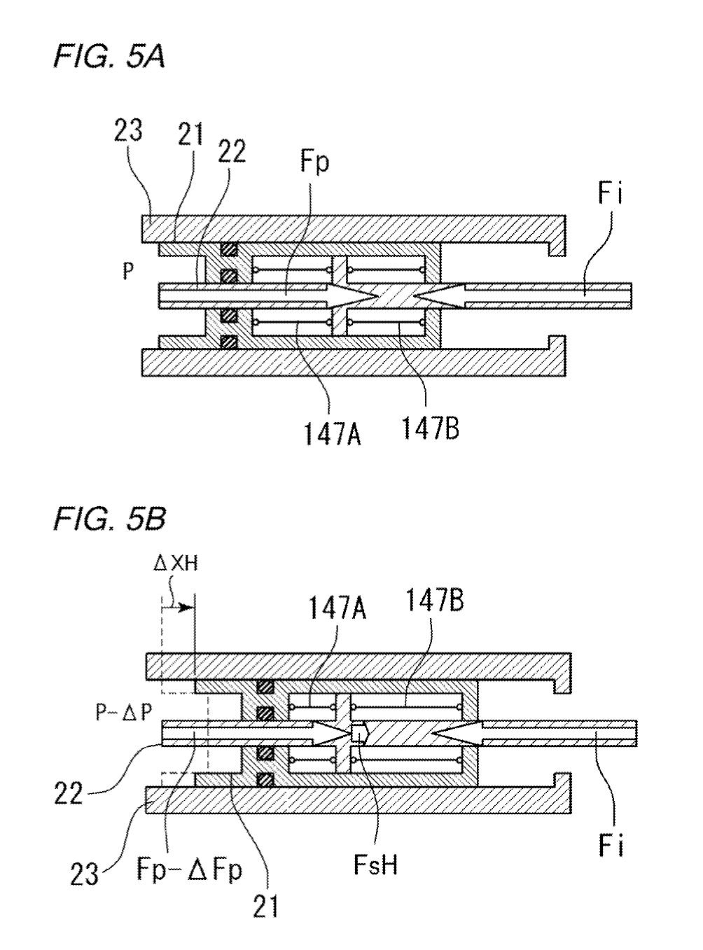

However, the brake hydraulic pressure P of the vehicle and the piston stroke X generally have the non-linear characteristic as illustrated in FIG. 4. Therefore, even if the amount of change ΔP in the hydraulic pressure is the same with respect to a state of the brake hydraulic pressure P, the amount of change ΔX in the piston stroke X is equal to the amount of change ΔXL in a low hydraulic pressure state and becomes equal to the amount of change ΔXH which is smaller than the above-mentioned amount of change ΔXL in a high hydraulic pressure state. Therefore, the ratio (ΔP/ΔX) of the amount of change LP in the hydraulic pressure and the amount of change ΔX in the piston stroke, which respectively correspond to the amount of change in the hydraulic pressure and that in the piston stroke, has a different value for each generated hydraulic pressure. For example, when the spring constant Ksp determined for the pressure reduction associated with the regenerative cooperative control performed in the low hydraulic pressure state is used as illustrated in FIGS. 3A and 3B, the pressure is reduced by the predetermined amount ΔP of the hydraulic pressure with the amount of backward movement of the piston, that is, the amount of change ΔXL. Therefore, a spring force FsL obtained by multiplying the spring constant Ksp and the amount of change ΔXL is generated to act as the reaction force on the brake pedal. On the other hand, as illustrated in FIGS. 5A and 5B, at the time of the pressure reduction associated with regenerative cooperative control performed in the high hydraulic pressure state, the pressure can be reduced by the predetermined amount ΔP of hydraulic pressure with the amount of backward movement of the piston, which is smaller than the amount of change ΔXL, specifically, the amount of change ΔXH. Therefore, only the spring force FsH obtained by multiplying the spring constant Ksp and the amount of change ΔXH is generated to reduce the reaction force on the brake pedal. Although not shown, in contrast to the case described above, a large amount of backward movement of the piston is required at the time of the pressure reduction associated with regenerative cooperative control performed at the low hydraulic pressure. As a result, the large spring force (Fs) is generated, and hence the reaction force on the brake pedal becomes large.

The first reference example involves the conflicting characteristics, which may respectively occur in the pressure reduction associated with the regenerative cooperative control performed in the high hydraulic pressure state and the pressure reduction associated with the regenerative cooperative control performed in the low hydraulic pressure state described above.

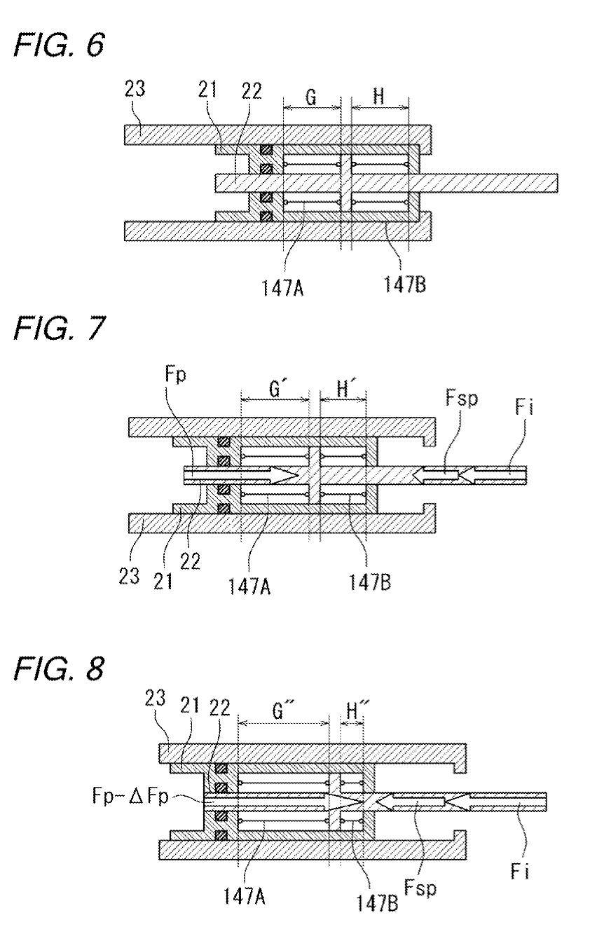

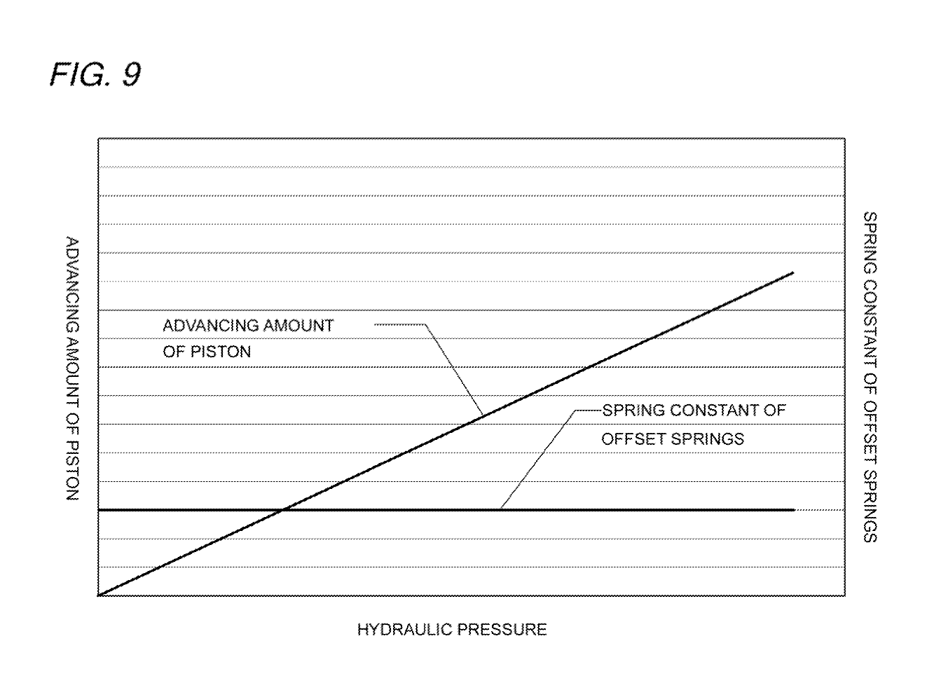

Next, the above-mentioned “advancement control under constant spring-constant characteristic conditions” is described as the second reference example. In the second reference example, the first offset spring 147A and the second offset spring 147B are provided as in the case of the first reference example, as illustrated in FIGS. 6 to 9. In place of the ECU 50 of this embodiment, an ECU (not shown) for performing the advancement control under constant spring-constant characteristic conditions is provided.

### ADVANCEMENT CONTROL UNDER CONSTANT SPRING-CONSTANT CHARACTERISTIC CONDITIONS (SECOND REFERENCE EXAMPLE)

FIG. 6 is a view schematically illustrating the correspondence relation between the input piston 22 and the booster piston 21, and the first offset spring 147A and the second offset spring 147B before the execution of the advancement control under constant spring-constant characteristic conditions (initial state) in the second reference example. FIGS. 7 and 8 are views schematically illustrating the correspondence relation between the input piston 22 and the booster piston 21, the first offset spring 147A, and the second offset spring 147B when the advancement control under constant spring-constant characteristic conditions is performed in the low hydraulic pressure state and the high hydraulic pressure state, respectively. In FIGS. 6 to 8, G, G′, and G″ represent a length of the first offset spring 147A in the respective states of FIGS. 6, 7, and 8, whereas H, H′, and H″ represent a length of the second offset spring 147B in the respective states of FIGS. 6, 7, and 8.

Although the booster piston 21 is moved forward by the amount equal to that of the stroke of the input piston 22 in the first reference example, the advancement control under constant spring-constant characteristic conditions is performed in the second reference example. Specifically, the control is performed so that the advancing amount of the booster piston 21 becomes larger as the stroke of the input piston 22 becomes larger as illustrated in FIGS. 7 and 8. With the control, the lengths of the first offset spring 147A and the second offset spring 147B respectively change from G to G′ to G″ and from H to H′ to H″.

When the advancement control under constant spring-constant characteristic conditions is performed, besides the reaction force (area A×hydraulic pressure) due to the hydraulic pressure, a force Fsp due to the extension and contraction of the first offset spring 147A and the second offset spring 147B (hereinafter, referred to as “spring force”) acts on the input piston 22. At this time, the force balance acting on the input piston 22 is as expressed by Formula (4).

Fi (advancement control)+Fsp=area A×P (4)

Formula (4) is transformed into Formula (5).

Fi (advancement control)+Fsp=area A×P−Fsp (5)

Note that, as a result of the advancement control (advancement control under constant spring-constant characteristic conditions) executed in the second embodiment, a tendency that “the reaction force Fi on the input piston 22 (input member) becomes smaller as the input to the input piston 22 (input member) becomes larger” is demonstrated in comparison with the equal-magnification control executed in the first reference example. In order to suppress the tendency, a brake pedal ratio is adjusted.

In the second reference example, the balance of the forces acting on the input piston 22 (input member) is as expressed by Formulae (6) and (7).

<Balance Before the Pressure Reduction Associated with Regenerative Cooperative Control>

Fi (before pressure reduction associated with regenerative cooperative control)=area A×P−Fsp (6)

<Balance After the Pressure Reduction Associated with Regenerative Cooperative Control>

Fi (after pressure reduction associated with regenerative cooperative control)=area A×(P−ΔP)+Ksp×ΔX−Fsp (7)

Then, in order to make Fi (before pressure reduction associated with regenerative cooperative control) and Fi (after pressure reduction associated with regenerative cooperative control) equal to each other, specifically, to suppress a change in pedal feel due to the pressure reduction associated with the regenerative cooperative control, as is apparent from the substitution of: Fi (before pressure reduction associated with regenerative cooperative control)=Fi (after pressure reduction associated with regenerative cooperative control) into Formulae (6) and (7), a characteristic expressed by Formula (8) is required to be provided.

area A×ΔP=Ksp×ΔX (8)

Then, Ksp is constant in the second reference example. Therefore, as in the first reference example, there is a problem in that a good pedal feel in the different hydraulic pressure states, that is, at the low hydraulic pressure and the high hydraulic pressure, in order words, the suppression of the occurrence of the fluctuation in pushing force on the brake pedal over the wide range of hydraulic pressure region cannot be realized.

In this embodiment, the problem is coped with by performing advancement control under non-linear spring constant characteristic conditions (“advancement control+non-linear characteristic of offset springs”) so as to appropriately improve the conflicting characteristics involved in the first reference example. Moreover, in this embodiment, for the problem of the second reference example using the advancement control under constant spring-constant characteristic conditions as described above, the advancement control under non-linear spring constant characteristic conditions (“advancement control+non-linear characteristic of offset springs”) is used to solve the problem of the second reference example.

Here, the effects of this embodiment are described mainly for the advancement control under non-linear spring constant characteristic conditions.

### [Advancement Control Under Non-Linear Spring Constant Characteristic Conditions (“Advancement Control+Non-Linear Characteristic of Offset Springs”)]

In this embodiment, the spring constant Ksp of the offset springs is increased according to the hydraulic pressure. Specifically, Ksp is provided with a non-linear characteristic as expressed by Formula (9) according to the relation ΔP/ΔX between the brake hydraulic pressure of the vehicle and the piston stroke (piston position), which is illustrated in FIG. 4, specifically, a gradient of the brake hydraulic pressure with respect to the stroke of the piston. The characteristic is illustrated in FIG. 10.

Ksp=area A×ΔP/ΔX (9)

However, the advancement control of this embodiment makes the stroke of the input piston 22 and the advancing amount of the booster piston 21 equal to each other. For example, when the input piston 22 is moved forward by one unit from the position when the brake pedal is not operated, the booster piston 21 is moved forward by two units. Therefore, the advancing amount is one unit.

By providing the characteristic expressed by Formula (9), specifically, the non-linear characteristic to the spring constant Ksp of the offset springs and, in addition, using the advancement control described above, the spring constant Ksp is controlled to change with respect to the stroke of the piston according to ΔP/ΔX corresponding to the gradient of the brake hydraulic pressure with respect to the stroke of the piston. As a result, for the reaction forces Fi on the input member before and after the regenerative cooperative control, which are respectively expressed by Formulae (10) and (11), Formula (12) is derived from Formula (9). Specifically, the change in the reaction force Fi after the pressure reduction associated with the regenerative cooperative control from that before the pressure reduction associated with the regenerative cooperative control can be made equal to zero or approximately zero.

<Balance Before Pressure Reduction Associated with Regenerative Cooperative Control>

Fi (before pressure reduction associated with regenerative cooperative control)=area A×P−Fsp (10)

<Balance After Pressure Reduction Associated with Regenerative Cooperative Control>

Fi (after pressure reduction associated with regenerative cooperative control)=area A×(P−ΔP)+(area A×ΔP/ΔX)×ΔX−Fsp (11)

Fi (before pressure reduction associated with regenerative cooperative control)=Fi (after pressure reduction associated with regenerative cooperative control) (12)

An operation performed at the time of the advancement control is described based on FIGS. 11A, 11B, 12A, and 12B. FIG. 11A illustrates the low hydraulic-pressure state at the time of normal braking. Further, when the hydraulic pressure is reduced, specifically, by the amount of change ΔP in the hydraulic pressure, in association with the regenerative cooperative control in the state illustrated in FIG. 11A, the reaction force due to the hydraulic pressure is reduced by area A×ΔP, and further, Fsp is reduced according to the amount of backward movement ΔXL of the piston as illustrated in FIG. 11B.

FIG. 12A illustrates the high hydraulic-pressure state at the time of normal braking. Further, when the pressure is reduced by ΔP in association with the regenerative cooperative control in the state illustrated in FIG. 12A as in the case of the low hydraulic pressure, the reaction force due to the hydraulic pressure-is reduced by area A×ΔP as in the case of the low hydraulic pressure, and further, Fsp is reduced according to the amount of backward movement ΔXH of the piston as illustrated in FIG. 12B.

Here, ΔXL>ΔXH is satisfied, whereas Ksp satisfies Formula (9). Therefore, a spring constant Ksp_{L} during a stroke X_{L} corresponding to a stroke performed in the low hydraulic pressure state is smaller than a spring constant Ksp_{H} during a stroke X_{H} corresponding to a stroke performed in the high hydraulic pressure state (Ksp_{L}<Ksp_{H}). Therefore, the amount of reduction in Fsp is approximately equal to the amount of reduction (A×ΔP) in the reaction force due to the hydraulic pressure both in the low hydraulic pressure state and the high hydraulic pressure state.

Specifically, each of the first offset spring 47A and the second offset spring 47B has the spring constant having the characteristic according to the ΔP/ΔX characteristic illustrated in FIG. 10. Moreover, as described above, the ECU 50 performs the advancement control for controlling the electric motor 31 so as to increase the advancing amount, that is, the advancing amount of the booster piston 21 with respect to the input piston 22 as the booster piston 21 of the master cylinder 1 is moved in the pressure-intensifying direction. In addition, the pressure reduction operation performed in association with the regenerative cooperative control is performed at the time of the advancement control. As a result, even when the pressure reduction associated with the regenerative cooperative control is performed in any one of the low hydraulic pressure state and the high hydraulic pressure state, the reaction force Fi to the pedal after the pressure reduction can be made equal to or approximately equal to that before the pressure reduction. Specifically, according to this embodiment, the generation of the fluctuation in pushing force on the brake pedal can be suppressed even when the pressure reduction operation associated with the regenerative cooperative control is performed in any of the low hydraulic pressure state and the high hydraulic pressure state, and in turn, over a wide range of hydraulic pressure region.

In this embodiment, the advancing amount with respect to the stroke of the piston has the linear characteristic, whereas the spring constant with respect to the advancing amount has the non-linear characteristic, in other words, the spring constant with respect to the stroke of the piston has the non-linear characteristic. However, the characteristics are not limited thereto. There may be used any non-linear characteristic configured so that the change in the spring constant with respect to the stroke of the piston and the change in gradient of the brake hydraulic pressure with respect to the stroke of the piston correspond to each other as a result of the combination of the two characteristics.

Here, “correspond” means the gradient of the spring constant and the gradient of the brake hydraulic pressure become close to each other at two or more points. For example, in the brake system having the characteristic illustrated in FIG. 4, if the spring constant is determined to correspond to the gradient of the brake hydraulic pressure on the left end and in the middle of the graph of the piston position (stroke of the piston), the fluctuation in pushing force on the brake pedal can be suppressed as compared with the prior art (the first reference example and the second reference example).

In this embodiment, the case where the first offset spring 47A and the second offset spring 47B are respectively formed of the coil springs and at least one of the springs (for example, spring 47A) is configured so that the pitch varies in a height direction (as a so-called irregular pitch coil spring) to provide the spring constant with the non-linear characteristic is exemplified. However, the way of providing the non-linear characteristic to the spring constant is not limited thereto. Each of the springs may be configured by using a helical coil spring or a barrel-shaped coil spring. Moreover, only any one of the first offset spring 47A and the second offset spring 47B may be provided as long as the offset spring has the above-mentioned characteristic.

The input member of this embodiment is linearly moved forward and backward by the operation of the brake pedal. However, the input member is not limited thereto and may be, for example, moved forward and backward in a rotating direction. As an example of the booster in which the input member is moved forward and backward in the rotating direction, there is known an electric booster described in Japanese Patent Application No. 2009-250929 filed by the applicant of the present invention. A first input shaft (with the reference numeral 11) in the electric booster corresponds to the input member of this embodiment. Moreover, a second input shaft (with the reference numeral 14) corresponds to the assist member, and biasing means (with the reference numerals 34 and 35) for elastically biasing the relative rotational positions of the first input shaft and the second input shaft to neutral positions corresponds to the spring member. Note that, the biasing means is provided between the first input shaft and the second input shaft through an intermediation of a brake pedal (with the reference symbol PD) to apply a biasing force to the first input shaft and the second input shaft.

Note that, the reason why “the spring constant of the spring member is set so as to vary according to the advancing amount of the assist member with respect to the input member” is because it is desired to set the spring constant of the spring member so that the reaction force Fi obtained after the pressure reduction is equal to or approximately equal to that obtained after the pressure reduction even if the pressure reduction associated with the regenerative cooperative control is performed at any one of the low hydraulic pressure and the high hydraulic pressure, by performing the pressure reduction operation associated with the regenerative cooperative control at the time of the advancement control as in the case of the present invention. However, setting of the spring constant is not limited thereto. The spring constant of the spring member may be set so that a difference between the reaction force Fi on the pedal at the low hydraulic pressure and the reaction force Fi on the pedal at the high hydraulic pressure is smaller than that in the case where a linear spring (spring with a constant spring constant) is used. For example, the spring member may be a spring having two-level spring constants.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2009-251939, filed on Nov. 2, 2009. The entire disclosure of Japanese Patent Application No. 2009-251939, filed on Nov. 2, 2009 including specification, claims, drawings and summary is incorporated herein by reference in its entirety.

What is claimed is:

1. An electric booster, comprising:
an input member which moves forward and backward by an operation of a brake pedal;
an assist member, provided so as to be movable relative to the input member, for moving a piston of a master cylinder;
an electric actuator for moving forward and backward the assist member;
control means for controlling the electric actuator according to movement of the input member by the brake pedal; and
a spring member, provided between the input member side and the assist member side, the spring member generating a biasing force applied to the input member which varies according to an amount of relative movement between the input member and the assist member, wherein:
a spring constant of the spring member is set so as to vary according to an advancing amount of the assist member with respect to the input member; and
the control means performs control so as to increase the advancing amount as the input member moves in a pressure-intensifying direction and is configured so that a change in the spring constant with respect to a stroke of the piston corresponds to a change in gradient of a brake hydraulic pressure with respect to the stroke of the piston.

2. An electric booster according to claim 1, wherein the spring member includes a pair of springs for retaining the input member and the assist member in neutral positions of a relative displacement when the brake pedal is out of the operation.

3. An electric booster according to claim 2, wherein a spring constant of at least one of the pair of springs increases with an increase in the advancing amount.

4. An electric booster according to claim 3, wherein the spring constant of the at least one of the pair of springs has a non-linear characteristic.

5. An electric booster according to claim 1, wherein the spring constant of the spring member increases with an increase in the advancing amount.

6. An electric booster according to claim 5, wherein the spring constant of the spring member has a non-linear characteristic.

7. An electric booster according to claim 1, wherein the spring constant of the spring member is set so that an amount of reduction in reaction force to the input member by the assist member at time of pressure reduction associated with regenerative cooperative control is compensated for over an entire region of a hydraulic pressure generated by the master cylinder.

8. An electric booster, comprising:
an input member which moves forward and backward by an operation of a brake pedal;
an assist member, provided so as to be movable relative to the input member, for moving a piston of a master cylinder;
an electric actuator for moving forward and backward the assist member;
control means for controlling the electric actuator according to movement of the input member by the brake pedal; and
a spring member provided between the input member and the assist member, the spring member generating a biasing force applied to the input member which varies according to an amount of relative movement between the input member and the assist member, wherein:
a spring constant of the spring member is set to increase as an amount of displacement of the assist member relative to the input member increases in a direction for intensifying a pressure of the piston of the master cylinder; and
the control means performs control so that an amount of movement of the assist member becomes larger than an amount of the movement of the input member as the piston of the master cylinder is moved in a pressure-intensifying direction, to thereby increase the spring constant of the spring member as the pressure of the master cylinder is intensified.

9. An electric booster according to claim 8, wherein the spring member includes a pair of springs for retaining the input member and the assist member in neutral positions of a relative displacement when the brake pedal is out of the operation.

10. An electric booster according to claim 9, wherein a spring constant of at least one of the pair of springs increases as the amount of the displacement of the assist member relative to the input member increases.

11. An electric booster according to claim 8, wherein the spring constant of the spring member has a non-linear characteristic that the spring constant increases with an increase in the amount of the displacement of the assist member relative to the input member.

12. An electric booster according to claim 8, wherein the spring constant of the spring member is set so that an amount of reduction in reaction force to the input member by the assist member at time of pressure reduction associated with regenerative cooperative control is compensated for over an entire region of a hydraulic pressure generated by the master cylinder.

13. An electric booster, comprising:
an input member which moves forward and backward by an operation of a brake pedal;
an assist member, provided so as to be movable relative to the input member, for moving a piston of a master cylinder;
an electric actuator for moving forward and backward the assist member; and
a spring member, provided between the input member and the assist member, the spring member generating a biasing force applied to the input member which becomes larger according to an amount of relative movement between the input member and the assist member,
wherein a spring constant of the spring member is set to increase as an amount of displacement of the assist member relative to the input member increases in a direction for intensifying a pressure of the piston of the master cylinder.

14. An electric booster according to claim 13, further comprising control means for controlling the electric actuator according to movement of the input member by the brake pedal,
wherein the control means performs control so that an amount of the movement of the assist member becomes larger than an amount of the movement of the input member as the piston of the master cylinder is moved in a pressure-intensifying direction, to thereby increase the spring constant of the spring member as the pressure of the master cylinder is intensified.

15. An electric booster according to claim 14, wherein the spring member includes a pair of springs for retaining the input member and the assist member in neutral positions of a relative displacement when the brake pedal is out of the operation.

16. An electric booster according to claim 15, wherein a spring constant of one of the pair of springs has a non-linear characteristic that the spring constant increases with an increase in the amount of the movement of the assist member with respect to the amount of the movement of the input member.

17. An electric booster according to claim 14, wherein the spring constant of the spring member has a non-linear characteristic that the spring constant increases with an increase in the amount of the movement of the assist member with respect to the amount of the movement of the input member.

18. An electric booster according to claim 14, wherein the spring constant of the spring member is set so that an amount of reduction in reaction force to the input member by the assist member at time of pressure reduction associated with regenerative cooperative control is compensated for over an entire area of a hydraulic pressure generated by the master cylinder.

19. An electric booster according to claim 13, wherein the spring member includes a pair of springs for retaining the input member and the assist member in neutral positions of a relative displacement when the brake pedal is out of the operation.

20. An electric booster according to claim 19, wherein a spring constant of one of the pair of springs has a non-linear characteristic that the spring constant increases as the amount of the displacement of the assist member relative to the input member increases.
